(19) United States
(12) Patent Application Publication
(10) Pub. No.: US 2025/0175273 A1
(43) Pub. Date: May 29, 2025

(54) GENERATIVE CHANNEL TRANSFORMATION FOR WIRELESS PROPAGATION SIMULATION

(71) Applicant: QUALCOMM Incorporated, San Diego, CA (US)

(72) Inventors: Tribhuvanesh OREKONDY, Wettingen (CH); June NAMGOONG, San Diego, CA (US); Thomas Markus HEHN, Delft (NL); Arash BEHBOODI, Amsterdam (NL); Taesang YOO, San Diego, CA (US); Akash Sandeep DOSHI, San Diego, CA (US)

(21) Appl. No.: 18/608,469

(22) Filed: Mar. 18, 2024

Related U.S. Application Data
(60) Provisional application No. 63/603,488, filed on Nov. 28, 2023.

(51) Int. Cl. H04B 17/391; H04B 17/00; H04B 17/382

(52) U.S. Cl. CPC H04B 17/3912; H04B 17/0087; H04B 17/382

(57) ABSTRACT

Certain aspects of the present disclosure provide techniques and apparatus for improved wireless channel modeling. A set of simulated channel information for a wireless signal propagating in a simulated physical space is generated, and a set of latent tensors is generated based on the set of simulated channel information using a transformation machine learning model. A channel estimate is generated based on the set of latent tensors using a decoder machine learning model. One or more actions are taken based on the channel estimate.

### CROSS-REFERENCE TO RELATED APPLICATION(S)

The present application for patent claims the benefit of priority to U.S. Provisional Appl. No. 63/603,488, filed Nov. 28, 2023, which is hereby incorporated by reference herein in its entirety.

### INTRODUCTION

Aspects of the present disclosure relate to wireless channel modeling.

There are a wide variety of use cases for Sixth Generation (6G) wireless communication systems, such as joint communication and sensing, which depend on more realistic and site-specific channel modeling for successful design and operation. For example, improved channel modeling may be useful for uses such as machine learning (ML)-based channel state information (CSI) feedback, beam prediction, positioning, network optimization, and the like. Such operations often rely on understanding the structure of the propagation channel, which in turn relies on realistic and site-specific channel modeling (for both better training of the data-driven algorithms, as well as more accurate assessment of the performance of such algorithms.)

In some conventional approaches, stochastic channel models have been employed in wireless system design and evaluation. Although such approaches have made significant contributions, these approaches are generally lacking in physical consistency and site-specificity. Some other conventional approaches use ray tracing (RT) based on the digital twin (DT) of the environment. Although the RT-based channels are often consistent with the description of the sites that are modeled, the computed channels are completely deterministic and faithful to such description. As a result, any discrepancy between the real world and the scene description for the DT used in the channel generation (as well as any deficiency in modeling the physics governing the channel generation) lead to a gap between the simulated channel and the real channel (referred to in some aspects as a “sim-to-real gap”).

### BRIEF SUMMARY

Certain aspects of the present disclosure provide a processor-implemented method of wireless channel estimation, comprising: generating a set of simulated channel information for a wireless signal propagating in a simulated physical space; generating a set of latent tensors based on the set of simulated channel information using a transformation machine learning model; generating a channel estimate based on the set of latent tensors using a decoder machine learning model; and taking one or more actions based on the channel estimate.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict certain aspects of the present disclosure and are therefore not to be considered limiting of the scope of this disclosure.

FIG. 1 depicts an example workflow to generate channel estimates using machine learning-based transformation models, according to some aspects of the present disclosure.

FIG. 2 depicts an example workflow for training an encoder, decoder, and vector quantization model for wireless channel estimation, according to some aspects of the present disclosure.

FIG. 3 depicts an example workflow for training a transformation machine learning model for wireless channel estimation, according to some aspects of the present disclosure.

FIG. 4 is a flow diagram depicting an example method for training machine learning models to perform wireless channel estimation, according to some aspects of the present disclosure.

FIG. 5 is a flow diagram depicting an example method for using machine learning models to perform wireless channel estimation, according to some aspects of the present disclosure.

FIG. 6 is a flow diagram depicting an example method for wireless channel estimation, according to some aspects of the present disclosure.

FIG. 7 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for providing improved wireless channel modeling.

In spite of recent progress in improving wireless channel modeling and estimation, some conventional channel models still inherently suffer from simulation-to-reality gaps, where the simulated channel(s) are inconsistent with actual field measurements (e.g., with the real channel in the physical space). Aspects of the present disclosure provide learning-based techniques that overcome (or at least reduce) this simulation gap and significantly improve channel estimation and modeling. In some aspect a deep generative model can be used to transform ray tracing (RT) simulated data to “real” data. In some aspects, a hybrid approach is provided. This hybrid approach may use a combination of simulations (e.g., using ray tracers) and real measurement data to learn an appropriate transformation from simulation to real data. In some aspects, using a simulated channel as a starting point, the system can then predict a transformed channel realization that is consistent with field measurement data.

Consequently, the techniques and architectures described herein can benefit from the spatial consistency and inductive biases of the ray tracer, and in addition the statistical nature of field measurement data.

In some aspects, a two-stage conditional generation approach is used.

In some aspects, to generate a channel for a specific placement of user equipment (UE) and a base station (e.g., a gNB) in a site, the estimation system can first use a wireless ray tracer (or other simulator) to generate a simulated channel for the devices. A machine learning model (e.g., a neural network) can then be leveraged to transform the generated simulated channel (denoted by hₛᵢₘ in some aspects) into an output “real” channel that mimics the measurement distribution (denoted by \tilde{h}ᵣₑₐₗ in some aspects). Specifically, in some aspects, the simulated channel corresponds to multipath components (MPCs) predicted by the ray tracer (or other simulator), and the real channels correspond to bandlimited channel impulse response (CIR) waveforms.

In some aspects, the transformation is performed using a conditional generation model (e.g., sampling from a distribution of measurement CIRs conditioned on the input simulated channel). In some aspects, to learn this transformation (e.g., to train the transformation model), the estimation system may use a two-stage training approach. In the first stage, an autoencoder may be trained to map real CIRs (e.g., real channel state information) into a relatively low-dimensional latent space. In the second stage, a generative model may be trained within this low-dimensional latent space. Each of these stages is described in more detail below.

### Example Workflow for Machine-Learning-Based Wireless Channel Estimation

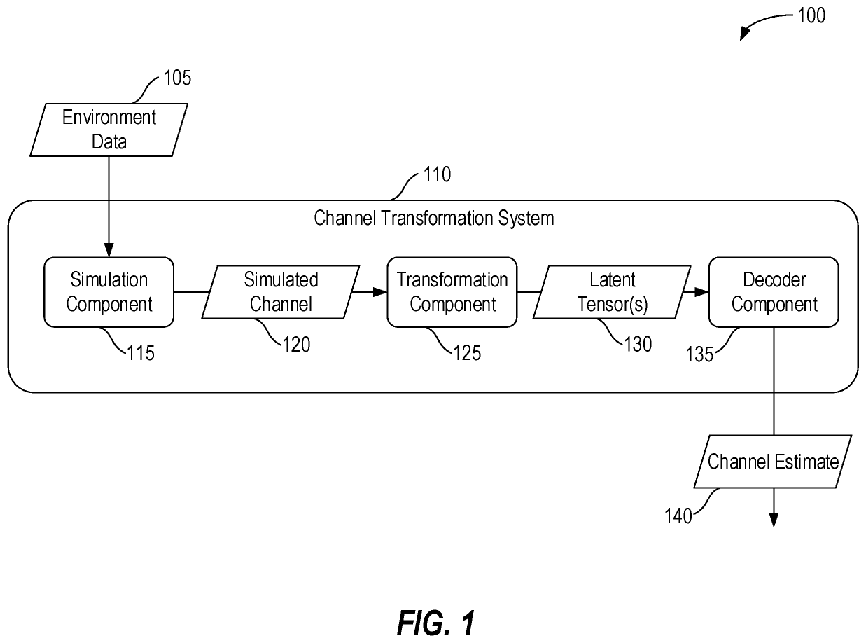

FIG. 1 depicts an example workflow 100 to generate channel estimates using machine learning-based transformation models, according to some aspects of the present disclosure.

In the illustrated example, a set of environment data 105 is accessed by a channel transformation system 110 to generate a channel estimate 140. As used here, “accessing” data may generally include receiving, requesting, retrieving, collecting, measuring, determining, generating, obtaining, or otherwise gaining access to the data. For example, the environment data 105 may be provided to the channel transformation system 110 by a user or other system, or may be generated or determined by the channel transformation system 110 (e.g., by taking one or more measurements in a physical space).

The environment data 105 is generally representative of the radio frequency (RF) properties of a physical space or site. For example, the environment data 105 may comprise data relating to the positioning and/or orientation of one or more objects in the space (e.g., desks, chairs, walls, doors, and the like), the RF characteristics of the object(s) (e.g., the permittivity, permeability, and/or conductivity of the object) with respect to one or more frequencies of interest (e.g., the frequencies that will be used for wireless communications, sensing, or other operations in the space). In some aspects, the environment data 105 corresponds to, or is used to construct, a “digital twin” of the physical space.

In some aspects, the goal of the wireless digital twin is to virtually replicate the real-world scene to faithfully simulate the wireless signal propagation. In some cases, wireless signal propagation is not only influenced by the geometry of the scene (e.g., the buildings, walls, foliage, and other objects in the environment), but also the precise positions and/or orientations of the transmitter and/or receiver in the space. In some aspects, the relevant information for an RF digital twin may be fundamentally different from other digital twins that aim to visually replicate a scene (e.g., which rely on accurate data relating to things like color and texture, while wireless digital twins are generally unaffected by most visual properties of objects in the space).

Generally, the propagation of wireless signals is influenced by properties that are not visible to the human eye, and are undetectable by many conventional sensors such as cameras and light detection and ranging (LiDAR) sensors. This discrepancy between the conventional sensors and the information relied upon for accurate wireless digital twin generation makes building a wireless digital twin particularly challenging in some aspects. In some aspects, the environment data 105 (representing the digital twin and/or used to generate the digital twin) is learned from measurements in the space. For example, in a similar manner to system identification and calibration techniques, such an approach may aim to directly minimize (or at least significantly reduce) the discrepancy between simulation (the digital twin) and reality (the actual RF properties of the space).

In some aspects, using such an approach, it is possible to learn the positions and/or orientations of transmitters, receivers, and/or RF scatterers (e.g., objects) in the scene. In some aspects, the system may further learn or infer the material properties of objects, such as the thickness, roughness, and/or dielectric properties of the objects in the scene (which can play a substantial role in the RF propagation behavior). In some conventional systems, capturing the dielectric properties relies on specialized test beds and equipment which is infeasible in practice for large-scale scenes. Thus, dielectric material properties may be good candidates to learn directly from RF measurements.

In some aspects, to learn the material properties, gradient-based optimization techniques may be used. However, such techniques rely on gradient information which is generally not available for most available ray tracers. In some aspects, however, it is possible to extract three-dimensional (3D) ray information using ray tracers along each ray, implementing the electromagnetic (EM) interactions with the intersected materials using various programming frameworks. In some aspects, to obtain the 3D trajectory of the rays, the simulation component 115 (e.g., using a ray tracer) executes using dummy or stand-in (e.g., default) materials. Using those rays, the change of the electric field along the ray may be computed to obtain gradient information with respect to the material properties.

In some aspects, the dielectric properties of the materials are generally characterized by the relative permittivity and the conductivity (assuming constant magnetic permeability of a vacuum everywhere), as discussed above. The permittivity generally indicates the polarizability of a dielectric (e.g., how well a material can store energy). The conductivity is generally related to energy dissipation of EM waves traveling through the medium. In some aspects, a lossless medium is non-conducting, while a perfect electric conductor (which is often used as an idealized assumption for metal), exhibits infinite conductivity. In some conventional solutions, the materials are commonly assumed to be homogenous within a single object, while in reality the material properties can change within an object (e.g., if there is a metal support in a concrete wall). While nonhomogeneous materials may be abstracted away in some cases, the polarization and the frequency of the EM wave should generally be taken into account. These dependencies should generally be considered when matching simulation and measurements, as the inferred material properties are specific to the used frequency.

In some aspects, based on the environment data 105, the simulation component 115 (or another component) computes simulated channel characteristics (such as the bandlimited CIR, the channel frequency response (CFR), and/or the received power). The materials in the space can then be learned by measuring the discrepancy between the channel characteristics of the simulated channel and the measured channel. This allows the simulation component 115 to build a relatively accurate digital twin (e.g., a simulator that is relatively accurate for the scene). In some aspects, as discussed above, the environment data 105 may itself include this digital twin, and the simulation component 115 may simply use the digital twin.

In the illustrated workflow 100, the simulation component 115 can generate a simulated channel 120 (e.g., a simulated channel estimate for one or more frequencies in the physical space). For example, as discussed above, the simulated channel 120 (which may be referred to as hₛᵢₘ in some aspects) may include or correspond to the MPCs predicted by the simulator (e.g., the ray tracer). As discussed above, however, the simulator generated and/or used by the simulation component 115 still generally has at least some level of error. That is, the simulated channel 120 may differ from the actual (real) channel in some ways.

As illustrated, to close this simulation gap, the simulated channel 120 is accessed by a transformation component 125. The transformation component 125 generally performs one or more operations using one or more trained machine learning models, as discussed in more detail below, to generate a set of one or more latent tensors 130 based on the simulated channel 120. In some aspects, as discussed in more detail below, the transformation component 125 may encode the simulated channel 120 using an encoder model (e.g., a small neural network) to generate a set of latent tensor(s) for the simulated channel 120. These latent tensors may then be processed using a transformation model (trained to transform simulated channel latents to real channel latents) to generate the latent tensor(s) 130.

In the illustrated example, the latent tensors 130 are then processed using a decoder component 135 to generate the channel estimate 140 (e.g., \tilde{h}ᵣₑₐₗ). In some aspects, as discussed in more detail below, the decoder component 135 uses a trained decoder model (e.g., the decoder portion of an autoencoder, as discussed in more detail below) to generate the channel estimate 140.

In this way, the channel estimate 140 may be a more realistic or accurate estimate of the real RF channel in the physical space (to which the environment data 105 corresponds), as compared to the simulated channel 120. In some aspects, as discussed above, the channel estimate 140 may then be used to perform or facilitate a wide variety of actions or operations. For example, the channel estimate 140 may enable improved positioning and/or sensing of objects in the space. That is, the channel transformation system 110 or another system may use the channel estimate 140 to accurately detect the presence and/or movement of objects in the physical space based on how the objects affect the RF signals (e.g., based on how the RF signals are changed by interacting with passive objects, such as people, such as through reflection, refraction, and the like).

As another example, the channel estimate 140 may be used to adjust one or more transmission parameters for the wireless signals transmitted in the physical space. For example, the channel transformation system 110 (or another system) may perform improved beamforming, ML-based channel state information (CSI) feedback, beam prediction, or any other network optimizations (or at least adjustments) that can utilize accurate channel estimates 140 to improve the functionality of the network itself (e.g., to improve throughput and/or bandwidth, reduce latency and/or interference, and generally improve network operations).

### Example Workflow for Machine-Learning-Based Wireless Channel Estimation

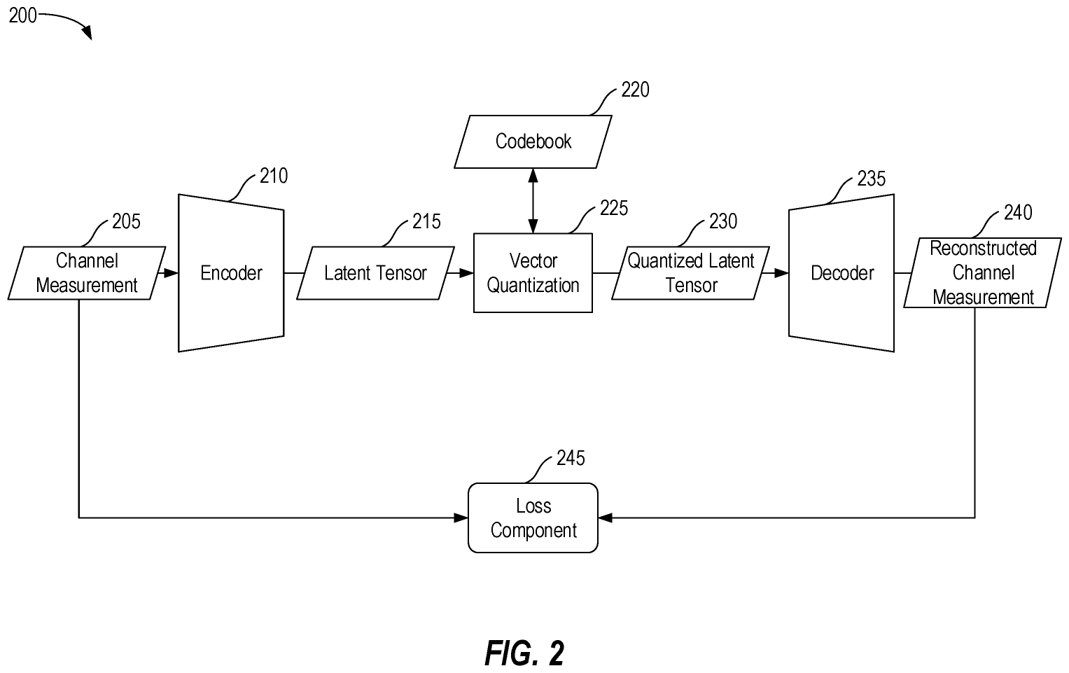

FIG. 2 depicts an example workflow 200 for training an encoder, decoder, and vector quantization model for wireless channel estimation, according to some aspects of the present disclosure. In some aspects, the workflow 200 is performed by a channel transformation system, such as the channel transformation system 110 of FIG. 1. In some aspects, the workflow 200 may be performed by other systems, such as a dedicated training system.

The workflow 200 depicts a process to train a codebook 220 and an autoencoder (e.g., an encoder 210 and a decoder 235) to compress wireless channels (e.g., channel estimates) to a latent space. That is, the workflow 200 may be used to train the autoencoder and codebook 220 to generate a relatively lower-dimensional compact representation of a channel measurement 205 (e.g., hᵣₑₐₗ). In some aspects, the channel measurement 205 corresponds to a real or actual measurement of the wireless channel in a physical space, as discussed above. In some aspects, the channel measurement 205 is relatively high-dimensional (e.g., multiple-input multiple-output (MIMO) channels over hundreds of taps). Training the autoencoder to generate a relatively lower dimensional representation may be beneficial to assist with subsequent generative modeling (e.g., to transform simulated channel estimates to “real” channel estimates), as the transformations can be restricted to this simpler (lower dimensionality) space. This can substantially improve the accuracy of the transformations, while further reducing computational complexity of the training and inferencing process.

In the illustrated workflow 200, the autoencoder uses convolutional neural network (CNN)-based model, where the latent representation of the channel measurement 205 corresponds to a one-dimensional sequence of discretized vectors, as discussed in more detail below.

As illustrated, the autoencoder comprises the encoder 210 (sometimes referred to as an encoder model and/or an encoder machine learning model, and denoted ε in some aspects) trained to generate latent tensors 215 (denoted zₑ in some aspects) based on input (real) channel measurements 205 (denoted x in some aspects), as well as the decoder 235 (sometimes referred to as a decoder model and/or a decoder machine learning model, and denoted D in some aspects) trained to generate reconstructed channel measurements 240 (denoted \tilde{x} in some aspects) based on an input quantized latent tensor 230 (sometimes referred to as a vector representation of the latent tensor, and denoted z_{q} in some aspects). As illustrated, the autoencoder further uses a vector quantization operation 225 to transform or quantize latent tensors 215 based on a trained or learned codebook 220 (denoted Z in some aspects) in order to generate the quantized latent tensor 230.

That is, in the illustrated workflow 200, the real channel measurement 205, which may have dimensionality N_{R}×N_{T}×N_{L}×2, is processed using the encoder 210 to generate a latent tensor 215. In some aspects, N_{R} corresponds to the number of receiving antenna used to generate the channel measurement 205, N_{T} is the number of transmitting antenna used to generate the channel measurement 205, and N_{L} is the number of taps (e.g., coefficients at each time step) in the channel measurement 205. In some aspects, the channel measurement 205 has a depth of two to indicate that, for each element (e.g., for each transmitting antenna and receiving antenna pair, at each time step or tap), two RF measurements (e.g., a magnitude and a phase) are measured. That is, the channel measurement 205 may indicate the CIR and/or CFR for the channel (e.g., the magnitude and/or phase of the signal for each antenna pair at a sequence of time steps).

In some aspects, the input channel measurement 205 is represented or processed as a sequence using the encoder 210 to generate the latent tensor 215. The encoder 210 is generally representative of a trained machine learning model (e.g., a convolutional neural network) that generally downsamples the input sequence and encodes the sequence in a latent space. In some aspects, the latent tensor 215 is a sequence of vectors and has dimensionality Nₗ×D, where Nₗ and D are hyperparameters. In some aspects,

$${N}_{ℓ} = \frac{{N}_{L}}{{2}^{m}} ,$$

where m is a downsampling factor (e.g., a hyperparameter used to downsample a sequence of length Nₗ by a factor of 2^{m}. For example, in some aspects, Nₗ has a value of seventeen, and D has a value of sixty-four.

In the illustrated example, the latent tensor 215 is processed using the vector quantization operation 225, which uses a learned codebook 220. The codebook 220 is generally a set of vectors having values learned (e.g., using backpropagation) during training of the autoencoder. In some aspects, the vector quantization operation 225 comprises replacing each element in the latent tensor 215 with the nearest entry in the codebook 220. For example, for each element in the latent tensor 215, the vector quantization operation 225 may use a nearest-neighbor approach to find the entry in the codebook 220 that is nearest to the element. The vector quantization operation 225 may then replace the element from the latent tensor 215 with the identified nearest element from the codebook 220. As a result, the vector quantization operation 225 generates the quantized latent tensor 230, which is a sequence of entries or values from the codebook 220.

In some aspects, as discussed above in more detail below, this vector quantization operation 225 may also be used during inferencing. For example, the output of the transformation model (e.g., the latent tensor 130 of FIG. 1) may be processed using the vector quantization operation 225, and the resulting tensor may then be provided to the decoder (e.g., the decoder component 135 of FIG. 1). In some aspects, during inferencing, the vector quantization operation 225 may be implemented as a part of the transformation model (e.g., the latent tensor 130 generated by the transformation model may be a quantized latent tensor), as part of the decoder model (e.g., as the first component of the decoder), or as a discrete operation between the transformation model and the decoder model.

As illustrated, the quantized latent tensor 230 is then processed by the decoder 235 in order to generate the reconstructed channel measurement 240). In some aspects, the reconstructed measurement has the same dimensionality as the original real channel measurement 205.

In some aspects, to train the autoencoder (e.g., to learn parameters for the encoder 210 and decoder 235, as well as the entries for the codebook 220), the channel measurement 205 and the reconstructed channel measurement 240 are accessed by a loss component 245. Although not depicted in the illustrated example, in some aspects, the loss component 245 may further evaluate other data such as the latent tensor 215 and/or the quantized latent tensor 230 to generate the loss(es) used to refine the models. The loss component 245 may generally use a variety of loss formulations. For example, in some aspects, a combination of reconstruction loss and commitment loss may be used to train the encoder 210, while the reconstruction loss may be used to update the decoder 235 and a vector quantization (VQ) loss may be used to update the codebook 220.

In some aspects, for example, the loss component 245 may generate the loss L_{autoencoder} using Equation 1 below, where x is the channel measurement 205, [symbol] (⋅) represents application of the decoder 235, eₖ is a set of vectors from the codebook 220 (e.g., the subset of codebook vectors that were selected to quantize the latent tensor 215), ∥⋅∥₂² indicates the squared Euclidean norm of ⋅, sg(⋅) is a stopgradient operator that is defined as identity at forward computation time and has zero partial derivatives, ε(⋅) represents application of the encoder 210, and β is a hyperparameter.

$${L}_{autoencoder} = {‖ x - ( {e}_{k} ) ‖}_{2}^{2} + {‖ sg ( ε ( x ) - {e}_{k} ) ‖}_{2}^{2} + β {‖ ( ε ( x ) - sg ( {e}_{k} ) ‖}_{2}^{2} \qquad ( 1 )$$

The training system may use backpropagation to generate gradients and update the parameters of the autoencoder, seeking to minimize (at least reduce) the cumulative loss. For example, the decoder 235 may seek to optimize the first component (e.g., the reconstruction loss) of Equation 1, the encoder 210 may seek to optimize both the first and the third components (e.g., the reconstruction loss and the commitment loss), and the codebook 220 may seek to optimize the second component (e.g., the VQ loss).

As illustrated, the components of the autoencoder (e.g., the encoder 210, the codebook 220, and the decoder 235) may be trained using any number of channel measurements 205 for any number of iterations. In some aspects, once the components of the autoencoder have been trained, the encoder 210 may be discarded or otherwise unused for inferencing, while the vector quantization operation 225 and the decoder 235 may be used to process generated latents (generated based on simulated channel measurements, as discussed above) in order to generate predicted channel estimates or measurements. In some aspects, the simulated channel estimates may be processed using an encoder, such as the encoder 210, to generate the latents which are used as input to the transformation model, as discussed above and in more detail below.

### Example Workflow for Machine-Learning-Based Wireless Channel Estimation

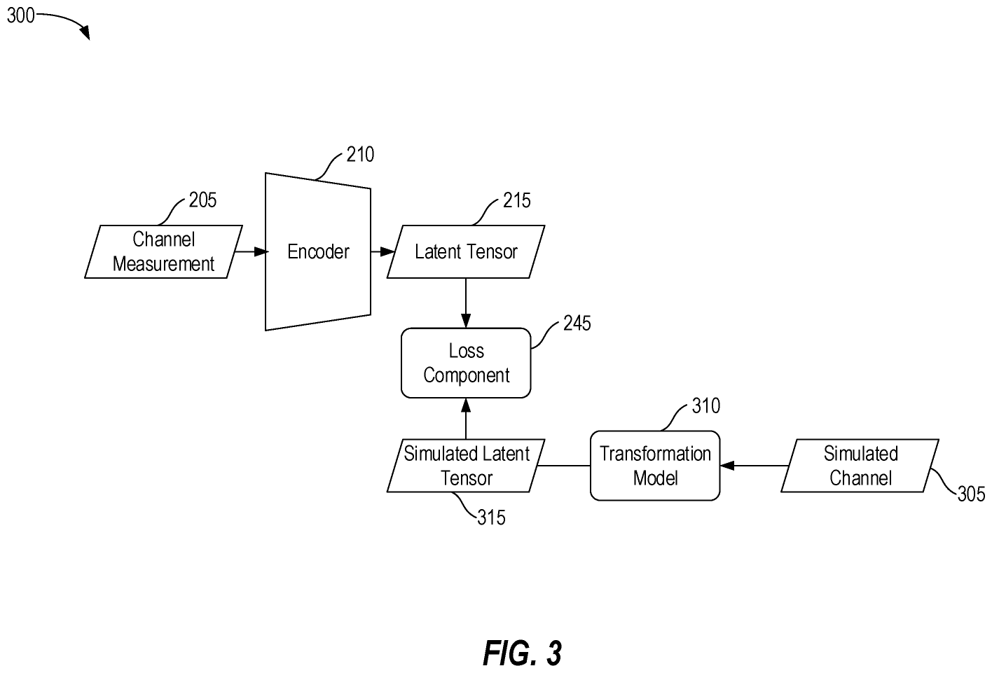

FIG. 3 depicts an example workflow 300 for training a transformation machine learning model for wireless channel estimation, according to some aspects of the present disclosure. In some aspects, the workflow 300 is performed by a channel transformation system, such as the channel transformation system 110 of FIG. 1. In some aspects, the workflow 300 may be performed by other systems, such as a dedicated training system (as discussed above with reference to FIG. 2). In some aspects, the workflow 300 is performed after the autoencoder model is trained, as discussed above.

In some aspects, as discussed above, the workflow 300 is used to train a conditional generation model to transform simulated channels into “real” channels (e.g., to close the simulation gap). As discussed above, using the workflow 200, the training system may have a trained autoencoder that learns a bidirectional mapping between real channel measurements (e.g., CIRs and/or CFRs) and a discrete latent space. As a result, the training system can effectively substitute the high-dimensional channel measurement(s) with low-dimensional latent counterparts. In the illustrated workflow 300, the training system then trains a transformation model (e.g., a deep generative network) to model the distribution of the latent code conditioned on the simulated channel from a simulation component (e.g., a ray tracer), such as the simulation component 115 of FIG. 1.

In some aspects, as discussed above, the latent code corresponds to the space of discrete one dimensional sequences (e.g., indices to elements of a pretrained codebook, such as the codebook 220 of FIG. 2). In some aspects, to generate discrete one dimensional sequences, a transformer architecture is leveraged, which has been shown to be highly effective in similar tasks.

Specifically, in the illustrated workflow 300, a set of real channel measurements 205 from a physical space may be processed using the trained encoder 210, as discussed above, to generate a latent tensor 215. Although not depicted in the illustrated example, in some aspects, the latent tensor 215 may be quantized based on a learned codebook (e.g., the codebook 220 of FIG. 2), such as by using a vector quantization operation (e.g., the vector quantization operation 225 of FIG. 2).

Further, as illustrated, a simulated channel 305 (e.g., a simulated channel estimate or measurement, such as a set of simulated MPCs generated using a simulator, such as the simulation component 115 of FIG. 1) are processed using a transformation model 310 to generate a simulated latent tensor 315. Although not depicted in the illustrated example, in some aspects, the simulated channel 305 may first be processed using an encoding operation, which generally corresponds to any operation or technique to encode the input simulated channel into the latent space. This (encoded) simulated channel 305 can then be then processed using the transformation model 310 to generate the simulated latent tensor 315. Although not depicted in the illustrated example, in some aspects, the simulated latent tensor 315 may be quantized based on a learned codebook (e.g., the codebook 220 of FIG. 2), such as by using a vector quantization operation (e.g., the vector quantization operation 225 of FIG. 2).

In some aspects, the transformation model 310 comprises a conditional generation model. As discussed above, the trained autoencoder learns (e.g., using the workflow 200) a bidirectional mapping between real CIRs (e.g., real channel measurements) and a discrete latent space. As a result, the training system can effectively substitute the high-dimensional channel measurements with their low-dimensional latent counterparts. In the workflow 300, the transformation model 310 (e.g., a deep generative network) may be trained to model the conditional distribution of the latents, given an input simulated channel 305.

In some aspects, to train the transformation model 310, the (real) latent tensor 215 for a real channel measurement 205 may be used, along with the simulated latent tensor 315, to generate a generative loss. For example, in the illustrated workflow 300, a simulated channel 305 (sometimes denoted as y) that corresponds to the channel measurement 205 may be generated (e.g., a simulated channel measurement for the same transmitter/receiver pair(s) as the channel measurement 205). As illustrated, the latent tensor 215 (or a vector quantized version thereof) and the simulated latent tensor 315 (or a vector quantized version thereof) are then accessed by the loss component 245.

The difference(s) between the real latent tensor 215 and the simulated latent tensor 315 may then be used to formulate one or more losses, which can be used to refine the parameters of the transformation model 310. In some aspects, the particular loss formulation(s) used to refine the transformation model 310 may vary depending on the particular implementation and architecture of the transformation model 310.

In some aspects, the particular architecture of the transformation model 310 may vary depending on the particular implementation. For example, in some aspects, the transformation model 310 uses a transformer architecture that generates the latent on dimensional sequence based on the simulated channel 305. In some aspects, to train the transformer architecture, the estimation system may seek to maximize (or at least increase) the negative log-likelihood(s) (NLLs) between the real and simulated latents.

For example, the loss L_{transformer} for the transformation model 310 may be defined using Equation 2 below, where z is the latent tensor 215 (generated by processing the channel measurement 205 (x) using the encoder 210), y is the simulated channel 305, and p(z|y)=

[symbol]

$${L}_{transformer} = 𝔼 [ - log ( p ( z \vert y ) ) ] \qquad ( 2 )$$

In some aspects, as discussed above, the simulated channel 305 may comprise a set of simulated MPCs. For example, the simulated channel 305 may be represented as a set or sequence of RF paths (e.g., a set of transmitter-receiver pairs), where, for each path, the simulated channel 305 comprises a magnitude of the gain of the signal, the phase of the gain, the time of flight, the angle of departure, the angle of arrival, and a mask element indicating whether the path is a valid path (e.g., with a value of one for valid paths and a value of zero for padded paths).

In some aspects, as another example, the transformation model 310 comprises a diffusion model (e.g., a diffusion machine learning model architecture). For example, the transformation model 310 may use a conditional diffusion approach, where the transformation model 310 iteratively denoises a noisy latent tensor conditioned based on the simulated channels 305 in order to generate the simulated latent tensor 315. In some aspects, therefore, the loss component 245 may generate a diffusion loss to refine the transformation model 310 for one or more samples (e.g., channel measurements 205 with corresponding simulated channels 305).

Generally, a variety of transformation model 310 architectures may be used depending on the particular implementation. As discussed above, once the transformation model 310 is trained, the training system may deploy the transformation model 310, the vector quantization operation 225 (using the learned codebook 220) of FIG. 2, and the decoder 235 of FIG. 2 to generate improved simulated channel estimates or measures during runtime. For example, as discussed above, a simulator (e.g., the simulation component 115 of FIG. 1) may generate a simulated channel (e.g., the simulated channel 120 of FIG. 1), and the transformer model 310 (e.g., used by the transformation component 125 of FIG. 1) may be used to process the simulated channel measurement in order to generate a simulated latent tensor (e.g., the latent tensor 130 of FIG. 1). This simulated latent tensor may then be optionally processed using a vector quantization operation (e.g., the vector quantization operation 225 of FIG. 2), and the resulting quantized latent may be processed using a decoder model (e.g., the decoder component 135 of FIG. 1 and/or the decoder 235 of FIG. 2) to generate a channel estimate (e.g., the channel estimate 140 of FIG. 1).

### Example Workflow for Machine-Learning-Based Wireless Channel Estimation

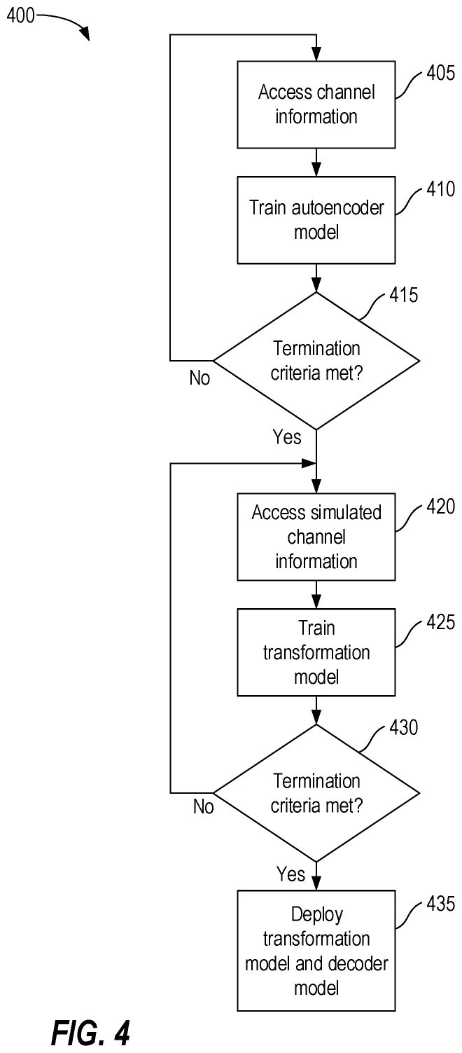

FIG. 4 is a flow diagram depicting an example method 400 for training machine learning models to perform wireless channel estimation, according to some aspects of the present disclosure. In some aspects, the method 400 is performed by a channel transformation system, such as the channel transformation system 110 of FIG. 1. In some aspects, the method 400 may be performed by other systems, such as a dedicated training system (as discussed above with reference to FIGS. 2-3).

At block 405, the training system accesses channel information (e.g., the channel measurement 205 of FIG. 2 and/or FIG. 3). For example, the channel information may correspond to one or more real channel measurements collected or generated based on one or more RF signals propagating in a physical space (e.g., between one or more antenna of one or more transmitters to one or more antenna of one or more receivers). In some aspects, the channel measurements may be collected based on RF signals transmitted between two devices (e.g., from a transmitter to a receiver) and/or signals transmitted and received by a single device (e.g., a transceiver). In some aspects, as discussed above, the channel information may comprise or correspond to the CFR and/or CIR of the channel across one or more taps (e.g., time steps).

At block 410, the training system trains an autoencoder model based on the channel information. For example, as discussed above with reference to the workflow 200 of FIG. 2, the training system may train an autoencoder comprising an encoder model (e.g., the encoder 210 of FIG. 2), a decoder model (e.g., the decoder 235 of FIG. 2), and a vector quantization operation that uses a learned codebook (e.g., the vector quantization operation 225 and codebook 220, each of FIG. 2) using the channel information.

In some aspects, as discussed, above, the training system may process the channel information using the encoder model of the autoencoder to generate a latent tensor (e.g., the latent tensor 215 of FIG. 2). This latent tensor may then be processed using the vector quantization operation to generate a quantized latent tensor (e.g., the quantized latent tensor 230) based on the codebook. Further, the training system may process the quantized latent tensor using the decoder model to generate a reconstructed channel measurement (e.g., the reconstructed channel measurement 240 of FIG. 2).

In some aspects, as discussed above, the training system may then generate one or more losses based at least in part on the channel information (accessed at block 405) and the reconstructed channel measurement. As discussed above, the loss(es) may then be used to update one or more parameters of the autoencoder (e.g., the parameters of the encoder model, the parameters of the decoder model, and/or the values of the codebook). In this way, the autoencoder iteratively learns to map channel measurements to the latent space (and vice versa).

At block 415, the training system determines whether one or more termination criteria are satisfied. Generally, the particular termination criteria may vary depending on the particular implementation. For example, in some aspects, the training system may determine whether additional channel measurements are available for training, whether a defined number of training iterations and/or a defined amount of time or computing resources have been spent training, whether the autoencoder has reached a desired level of accuracy, and the like. If the termination criteria are not met, the method 400 returns to block 405. If the termination criteria are met, the method 400 continues to block 420. Although the illustrated example depicts a sequential process (where the autoencoder is trained based on each channel measurement independently) for conceptual clarity (e.g., using stochastic gradient descent), in some aspects, the training system may train the autoencoder using multiple measurements at a time (e.g., using batch gradient descent).

At block 420, the training system accesses simulated channel information (e.g., the simulated channel 305 of FIG. 3). For example, the simulated channel information may correspond to one or more simulated channel measurements or estimates, generated based on a simulated environment (e.g., a digital twin) corresponding to a physical environment, such as using the simulation component 115 of FIG. 1. In some aspects, the simulated channel information corresponds to one or more simulated RF signals propagating in a simulated space (e.g., between one or more antenna of one or more transmitters to one or more antenna of one or more receivers). In some aspects, the simulated space corresponds to the physical space to which the channel measurements (accessed at block 405) corresponds. In some aspects, as discussed above, the training system may train site-specific models, such that the autoencoder and/or transformation model are trained based on data corresponding to a specific site, and are used to generate improved channel estimates for the specific site. In some aspects, as discussed above, the simulated channel information may comprise or correspond to the MPCs of the channel across one or more paths and/or taps.

At block 425, the training system trains a transformation model based on the simulated channel information and the channel information (accessed at block 405). For example, as discussed above with reference to the workflow 300 of FIG. 3, the training system may train a model such as the transformation model 310 of FIG. 3 using the simulated channel information. In some aspects, as discussed above, the training system may train the transformation model based on pairs of data (e.g., a real channel measurement and a corresponding simulated channel measurement).

In some aspects, as discussed, above, the training system may process a sample of real channel information (e.g., accessed at block 405) using the encoder model of the autoencoder (trained at block 410) to generate a latent tensor (e.g., the latent tensor 215 of FIG. 3). This latent tensor may then be optionally processed using the trained vector quantization operation to generate a quantized latent tensor, as discussed above. Further, the training system may process the simulated channel information (accessed at block 420) using the transformation model to generate a simulated latent tensor (e.g., the simulated latent tensor 315 of FIG. 3). In some aspects, as discussed above, the training system may optionally process the simulated channel information using an encoder operation prior to using the transformation model, and/or may use the trained vector quantization operation to generate a quantized simulated latent tensor.

In some aspects, as discussed above, the training system may then generate one or more losses based at least in part on the latent tensor (or quantized latent tensor) corresponding to the real channel measurement, and the latent tensor (or quantized latent tensor) corresponding to the simulated channel measurement. As discussed above, the loss(es) may then be used to update one or more parameters of the transformation model. In this way, the transformation model iteratively learns to map simulated channel measurements (or latents therefrom) to “real” channel measurements (or latents).

At block 430, the training system determines whether one or more termination criteria are satisfied. Generally, the particular termination criteria may vary depending on the particular implementation. For example, in some aspects, the training system may determine whether additional simulated channel measurements are available for training, whether a defined number of training iterations and/or a defined amount of time or computing resources have been spent training, whether the transformation model has reached a desired level of accuracy, and the like. If the termination criteria are not met, the method 400 returns to block 420. If the termination criteria are met, the method 400 continues to block 435. Although the illustrated example depicts a sequential process (where the transformation model is trained based on each simulated channel measurement independently) for conceptual clarity (e.g., using stochastic gradient descent), in some aspects, the training system may train the transformation model using multiple simulated measurements at a time (e.g., using batch gradient descent).

At block 435, the training system deploys the transformation model and the decoder model (and, optionally, the vector quantization operation with the learned codebook) for inferencing. As used herein, “deploying” the machine learning model may generally include any operations used to prepare or provide the model for runtime use. For example, the transformation model and decoder model may be instantiated locally, the learned parameters of the models may be provided to another system (e.g., the channel transformation system 110 of FIG. 1), and the like.

### Example Workflow for Machine-Learning-Based Wireless Channel Estimation

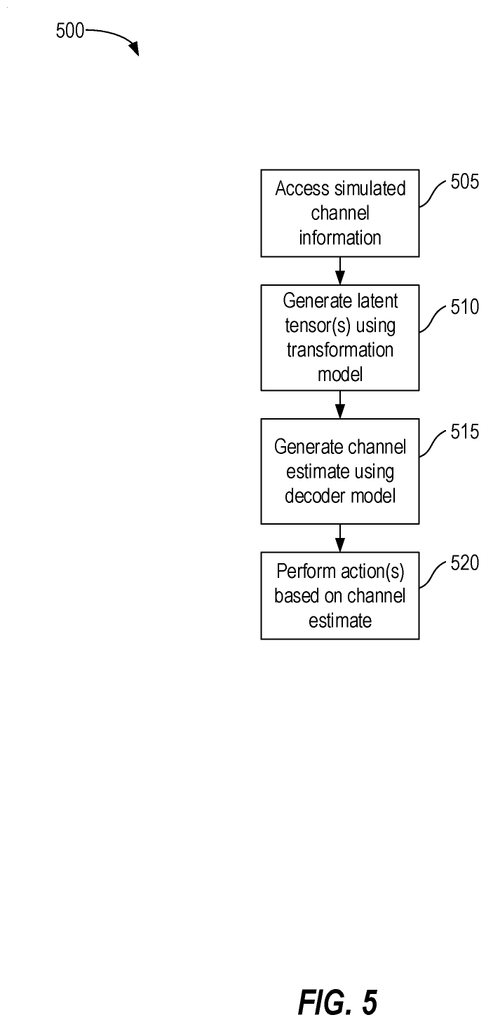

FIG. 5 is a flow diagram depicting an example method 500 for using machine learning models to perform wireless channel estimation, according to some aspects of the present disclosure. In some aspects, the method 500 is performed by a channel transformation system, such as the channel transformation system 110 of FIG. 1. In some aspects, the method 500 may be performed by other systems, such as a dedicated training system (as discussed above with reference to FIGS. 2-4).

At block 505, the channel transformation system accesses simulated channel information (e.g., the simulated channel 120 of FIG. 1). In some aspects, as discussed above, the simulated channel information corresponds to a simulated measurement of a wireless channel (e.g., of a simulated wireless signal propagating in a simulated physical space). In some aspects, as discussed above, the simulated physical space may correspond to a real physical space (e.g., the simulated physical space may be a digital twin of the real physical space, such as a virtual recreation of the object(s) in the physical space, including the positioning, orientation, RF properties, and the like of such object(s)). In some aspects, the simulated channel information comprises simulated MPCs of the wireless signal.

At block 510, the channel transformation system generates a latent tensor (e.g., the latent tensor 130 of FIG. 1) based on processing the simulated channel information using a transformation model (e.g., by the transformation component 125 of FIG. 1 and/or the transformation model 310 of FIG. 3). In some aspects, as discussed above, the channel transformation system may optionally first process the simulated channel information using an encoder, as discussed above. The output of this encoder may then be processed using the transformation model. In some aspects, as discussed above, the channel transformation system may optionally process the latent tensor using a vector quantization operation (e.g., using a learned codebook, such as the codebook 220 of FIG. 2), as discussed above.

At block 515, the channel transformation system generates a channel estimate for the wireless channel in the real physical space by processing the latent tensor (which may be a quantized latent tensor, as discussed above), using a decoder model (e.g., the decoder component 135 of FIG. 1 and/or the decoder 235 of FIG. 2). In some aspects, as discussed above, the channel estimate may comprise the estimated CFR and/or CIR for the wireless channel (e.g., for wireless signals propagating in the real physical space to which the simulated channel information corresponds). That is, the channel transformation system may use a site-specific model to predict channel estimates for the specific site (e.g., where each site, if multiple exist, may use a corresponding site-specific model).

At block 520, the channel transformation system optionally performs one or more actions based on the channel estimate. For example, as discussed above, the improved channel estimate may enable improved positioning and/or sensing of objects in the real physical space. That is, the channel transformation system or another system may use the channel estimate to accurately detect the presence and/or movement of objects in the physical space based on how the objects affect the RF signals (e.g., based on how the RF signals are changed by interacting with passive objects, such as people, such as through reflection, refraction, and the like).

As another example, the channel estimate may be used to adjust one or more transmission parameters for the wireless signals transmitted in the real physical space. For example, the channel transformation system (or another system) may perform improved beamforming, ML-based channel state information (CSI) feedback, beam prediction, or any other network optimizations (or at least adjustments) that can utilize accurate channel estimates to improve the functionality of the network itself (e.g., to improve throughput and/or bandwidth, reduce latency and/or interference, and generally improve network operations) in the real physical space.

### Example Workflow for Machine-Learning-Based Wireless Channel Estimation

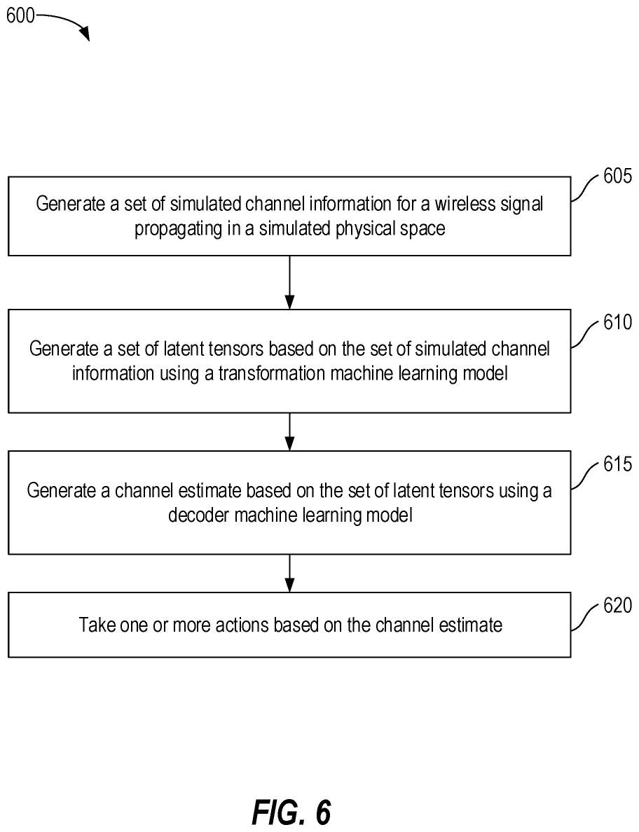

FIG. 6 is a flow diagram depicting an example method for wireless channel estimation, according to some aspects of the present disclosure. In some aspects, the method 600 is performed by a channel transformation system, such as the channel transformation system 110 of FIG. 1 and discussed with reference to FIGS. 2-5).

At block 605, a set of simulated channel information for a wireless signal propagating in a simulated physical space is generated.

At block 610, a set of latent tensors is generated based on the set of simulated channel information using a transformation machine learning model.

At block 615, a channel estimate is generated based on the set of latent tensors using a decoder machine learning model.

At block 620, one or more actions are taken based on the channel estimate.

In some aspects, the transformation machine learning model comprises at least one of: (i) a transformer model, or (ii) a diffusion model.

In some aspects, generating the channel estimate comprises generating a vector representation based on processing the set of latent tensors using a vector quantization operation, and processing the vector representation using the decoder machine learning model.

In some aspects, the vector quantization operation comprises a learned codebook.

In some aspects, the simulated physical space corresponds to a real physical space, and the transformation machine learning model is site-specific to the real physical space.

In some aspects, taking the one or more actions comprises at least one of: (i) adjusting one or more transmission parameters for wireless signals transmitted in the real physical space, or (ii) performing positioning for one or more objects in the real physical space.

In some aspects, the channel estimate comprises at least one of: (i) a channel frequency response, or (ii) a channel impulse response.

In some aspects, the simulated channel information comprises simulated multipath components.

### Example Processing System for Wireless Channel Estimation

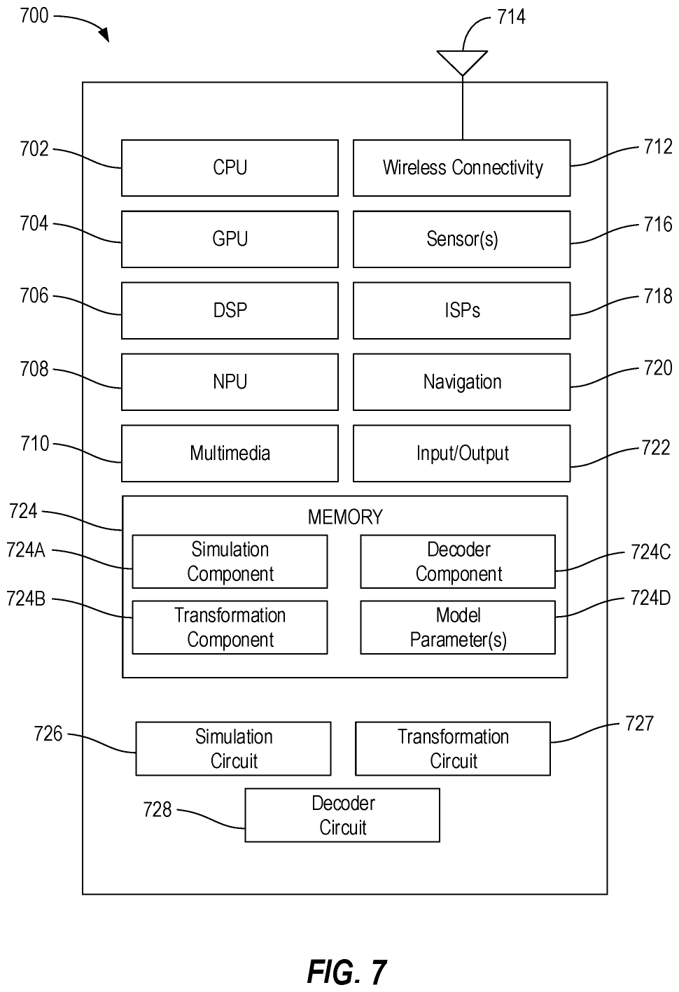

FIG. 7 depicts an example processing system 700 configured to perform various aspects of the present disclosure, including, for example, the techniques and methods described with respect to FIGS. 1-6. In some aspects, the processing system 700 may correspond to a channel transformation system. For example, the processing system 700 may correspond to a system that trains machine learning models and/or uses models for channel estimation. Although depicted as a single system for conceptual clarity, in some aspects, as discussed above, the operations described below with respect to the processing system 700 may be distributed across any number of devices or systems.

The processing system 700 includes a central processing unit (CPU) 702, which in some examples may be a multi-core CPU. Instructions executed at the CPU 702 may be loaded, for example, from a program memory associated with the CPU 702 or may be loaded from a memory partition (e.g., a partition of a memory 724).

The processing system 700 also includes additional processing components tailored to specific functions, such as a graphics processing unit (GPU) 704, a digital signal processor (DSP) 706, a neural processing unit (NPU) 708, a multimedia component 710 (e.g., a multimedia processing unit), and a wireless connectivity component 712.

An NPU, such as the NPU 708, is generally a specialized circuit configured for implementing the control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 708, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece of data through an already trained model to generate a model output (e.g., an inference).

In some implementations, the NPU 708 is a part of one or more of the CPU 702, the GPU 704, and/or the DSP 706.

In some examples, the wireless connectivity component 712 may include subcomponents, for example, for third generation (3G) connectivity, fourth generation (4G) connectivity (e.g., Long-Term Evolution (LTE)), fifth generation (5G) connectivity (e.g., New Radio (NR)), Wi-Fi connectivity, Bluetooth connectivity, and other wireless data transmission standards. The wireless connectivity component 712 is further coupled to one or more antennas 714.

The processing system 700 may also include one or more sensor processing units 716 associated with any manner of sensor, one or more image signal processors (ISPs) 718 associated with any manner of image sensor, and/or a navigation processor 720, which may include satellite-based positioning system components (e.g., GPS or GLONASS) as well as inertial positioning system components.

The processing system 700 may also include one or more input and/or output devices 722, such as screens, touch-sensitive surfaces (including touch-sensitive displays), physical buttons, speakers, microphones, and the like.

In some examples, one or more of the processors of the processing system 700 may be based on an ARM or RISC-V instruction set.

The processing system 700 also includes a memory 724, which is representative of one or more static and/or dynamic memories, such as a dynamic random access memory, a flash-based static memory, and the like. In this example, the memory 724 includes computer-executable components, which may be executed by one or more of the aforementioned processors of the processing system 700.

In particular, in this example, the memory 724 includes a simulation component 724A, a transformation component 724B, and a decoder component 724C. Although not depicted in the illustrated example, the memory 724 may also include other components, such as a training component to compute losses and update model parameters (e.g., the loss component 245 of FIGS. 2-3), an inferencing component to use trained models during runtime, an encoder component (e.g., part of an autoencoder), a vector quantization component, and the like. Though depicted as discrete components for conceptual clarity in FIG. 7, the illustrated components (and others not depicted) may be collectively or individually implemented in various aspects.

As illustrated, the memory 724 also includes a set of model parameters 724D (e.g., parameters of one or more machine learning models or components thereof). For example, the model parameters 724D may include parameters for an autoencoder (e.g., the encoder 210, decoder 235, and/or codebook 220 of FIG. 2) and/or a generation or transformation model (e.g., the transformation model 310 of FIG. 3). Although not depicted in the illustrated example, the memory 724 may also include other data such as training data (e.g., real channel measurement data and corresponding simulated channel measurement data).

The processing system 700 further comprises a simulation circuit 726, a transformation circuit 727, and a decoder circuit 728. The depicted circuits, and others not depicted (such as an inferencing circuit), may be configured to perform various aspects of the techniques described herein.

The simulation component 724A and/or the simulation circuit 726 (which may correspond to the simulation component 115 of FIG. 1) may be used to generate simulated channel measurements, as discussed above. For example, the simulation component 724A and/or the simulation circuit 726 may simulate the propagation of one or more wireless signals in a simulated physical space in order to generate simulated channel measurements for the space.

The transformation component 724B and/or the transformation circuit 727 (which may correspond to the transformation component 125 of FIG. 1 and/or the transformation model 310 of FIG. 3) may be used to transform simulated channel measurements into a latent-space representation of real channel measurements, as discussed above. For example, the transformation component 724B and/or the transformation circuit 727 may generate a latent representation of simulated channel measurements, and this latent tensor may then be processed using a transformation model to generate a latent tensor for a “real” channel estimate.

The decoder component 724C and/or the decoder circuit 728 (which may correspond to the decoder component 135 of FIG. 1 and/or the decoder 235 of FIG. 2) may be used to use a decoder model to generate predicted or reconstructed channel measurements based on input latent representations (e.g., simulated latents that have been processed using a transformation model).

Though depicted as separate components and circuits for clarity in FIG. 7, the simulation circuit 726, the transformation circuit 727, and the decoder circuit 728 may collectively or individually be implemented in other processing devices of the processing system 700, such as within the CPU 702, the GPU 704, the DSP 706, the NPU 708, and the like.

Generally, the processing system 700 and/or components thereof may be configured to perform the methods described herein.

Notably, in other aspects, aspects of the processing system 700 may be omitted, such as where the processing system 700 is a server computer or the like. For example, the multimedia component 710, the wireless connectivity component 712, the sensor processing units 716, the ISPs 718, and/or the navigation processor 720 may be omitted in other aspects. Further, aspects of the processing system 700 maybe distributed between multiple devices.

### Example Clauses

Implementation examples are described in the following numbered clauses:

Clause 1: A method, comprising: generating a set of simulated channel information for a wireless signal propagating in a simulated physical space; generating a set of latent tensors based on the set of simulated channel information using a transformation machine learning model; generating a channel estimate based on the set of latent tensors using a decoder machine learning model; and taking one or more actions based on the channel estimate.

Clause 2: A method according to Clause 1, wherein the transformation machine learning model comprises at least one of: (i) a transformer model, or (ii) a diffusion model.

Clause 3: A method according to any of Clauses 1-2, wherein generating the channel estimate comprises: generating a vector representation based on processing the set of latent tensors using a vector quantization operation; and processing the vector representation using the decoder machine learning model.

Clause 4: A method according to Clause 3, wherein the vector quantization operation comprises a learned codebook.

Clause 5: A method according to any of Clauses 1-4, wherein: the simulated physical space corresponds to a real physical space, and the transformation machine learning model is site-specific to the real physical space.

Clause 6: A method according to Clause 5, wherein taking the one or more actions comprises at least one of: (i) adjusting one or more transmission parameters for wireless signals transmitted in the real physical space, or (ii) performing positioning for one or more objects in the real physical space.

Clause 7: A method according to any of Clauses 1-6, wherein the channel estimate comprises at least one of: (i) a channel frequency response, or (ii) a channel impulse response.

Clause 8: A method according to any of Clauses 1-7, wherein the simulated channel information comprises simulated multipath components.

Clause 9: A processing system comprising: at least one memory comprising computer-executable instructions; and one or more processors coupled to the at least one memory and configured to execute the computer-executable instructions and cause the processing system to perform a method in accordance with any of Clauses 1-8.

Clause 10: A processing system comprising means for performing a method in accordance with any of Clauses 1-8.

Clause 11: A non-transitory computer-readable medium comprising computer-executable instructions that, when executed by one or more processors of a processing system, cause the processing system to perform a method in accordance with any of Clauses 1-85.

Clause 12: A computer program product embodied on a computer-readable storage medium comprising code for performing a method in accordance with any of Clauses 1-8.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system comprising:
one or more memories comprising processor-executable instructions; and
one or more processors configured to execute the processor-executable instructions and cause the processing system to:
generate a set of simulated channel information for a wireless signal propagating in a simulated physical space;
generate a set of latent tensors based on the set of simulated channel information using a transformation machine learning model;
generate a channel estimate based on the set of latent tensors using a decoder machine learning model; and
take one or more actions based on the channel estimate.

2. The processing system of claim 1, wherein the transformation machine learning model comprises at least one of: (i) a transformer model, or (ii) a diffusion model.

3. The processing system of claim 1, wherein, to generate the channel estimate, the one or more processors are configured to execute the processor-executable instructions and cause the processing system to:
generate a vector representation based on processing the set of latent tensors using a vector quantization operation; and
process the vector representation using the decoder machine learning model.

4. The processing system of claim 3, wherein the vector quantization operation comprises a learned codebook.

5. The processing system of claim 1, wherein:
the simulated physical space corresponds to a real physical space, and
the transformation machine learning model is site-specific to the real physical space.

6. The processing system of claim 5, wherein, to take the one or more actions, the one or more processors are configured to execute the processor-executable instructions and cause the processing system to:
(i) adjust one or more transmission parameters for wireless signals transmitted in the real physical space, or
(ii) perform positioning for one or more objects in the real physical space.

7. The processing system of claim 1, wherein the channel estimate comprises at least one of: (i) a channel frequency response, or (ii) a channel impulse response.

8. The processing system of claim 1, wherein the simulated channel information comprises simulated multipath components.

9. A processor-implemented method of wireless channel estimation, comprising:
generating a set of simulated channel information for a wireless signal propagating in a simulated physical space;
generating a set of latent tensors based on the set of simulated channel information using a transformation machine learning model;
generating a channel estimate based on the set of latent tensors using a decoder machine learning model; and
taking one or more actions based on the channel estimate.

10. The processor-implemented method of claim 9, wherein the transformation machine learning model comprises at least one of: (i) a transformer model, or (ii) a diffusion model.

11. The processor-implemented method of claim 9, wherein generating the channel estimate comprises:
generating a vector representation based on processing the set of latent tensors using a vector quantization operation; and
processing the vector representation using the decoder machine learning model.

12. The processor-implemented method of claim 11, wherein the vector quantization operation comprises a learned codebook.

13. The method of claim 9, wherein:
the simulated physical space corresponds to a real physical space, and
the transformation machine learning model is site-specific to the real physical space.

14. The method of claim 13, wherein taking the one or more actions comprises at least one of:
(i) adjusting one or more transmission parameters for wireless signals transmitted in the real physical space, or
(ii) performing positioning for one or more objects in the real physical space.

15. The processor-implemented method of claim 9, wherein the channel estimate comprises at least one of: (i) a channel frequency response, or (ii) a channel impulse response.

16. The processor-implemented method of claim 9, wherein the simulated channel information comprises simulated multipath components.

17. One or more non-transitory computer-readable media comprising instructions that, when executed by one or more processors of a processing system, cause the processing system to:
generate a set of simulated channel information for a wireless signal propagating in a simulated physical space;
generate a set of latent tensors based on the set of simulated channel information using a transformation machine learning model;
generate a channel estimate based on the set of latent tensors using a decoder machine learning model; and
take one or more actions based on the channel estimate.

18. The one or more non-transitory computer-readable media of claim 17, wherein, to generate the channel estimate, the one or more non-transitory computer-readable media comprise instructions that, when executed by the one or more processors, cause the processing system to:
generate a vector representation based on processing the set of latent tensors using a vector quantization operation comprising a learned codebook; and
process the vector representation using the decoder machine learning model.

19. The one or more non-transitory computer-readable media of claim 17, wherein:
the simulated physical space corresponds to a real physical space, and
the transformation machine learning model is site-specific to the real physical space.

20. The one or more non-transitory computer-readable media of claim 19, wherein, to take the one or more actions, the one or more non-transitory computer-readable media comprise instructions that, when executed by the one or more processors, cause the processing system to:
(i) adjust one or more transmission parameters for wireless signals transmitted in the real physical space, or
(ii) perform positioning for one or more objects in the real physical space.
